(19) United States
(12) Patent Application Publication
(10) Pub. No.: US 2020/0065902 A1
(43) Pub. Date: Feb. 27, 2020

(54) TOXICITY IN A TRADING NETWORK

(71) Applicant: CFPH, LLC, New York, NY (US)

(72) Inventor: Kevin FOLEY, New York, NY (US)

(21) Appl. No.: 16/549,130

(22) Filed: Aug. 23, 2019

Related U.S. Application Data
(60) Provisional application No. 62/721,748, filed on Aug. 23, 2018.

(51) Int. Cl. G06Q 40/04; H04L 29/06

(52) U.S. Cl. CPC G06Q 40/04; H04L 63/0414

(57) ABSTRACT

A method of operating a distributed trading platform may include monitoring, over a communication network in real time, trading activity information indicating trading activities of respective second participants, in which the second participants are liquidity takers; determining in real time toxicity ratings respectively for the second participants; receiving, over the communication network from a first participant system of a liquidity provider, a first order; and automatically in response to receiving the first order and in real time, determining toxicity augments from the toxicity ratings respectively of the second participants, and transmitting, over the communication network, first order display information to second participant systems respectively of the second participants, to cause display on a graphical user interface (GUI) of a display of each second participant system of the second participant systems of an indication of the first order with the toxicity augment corresponding to the second participant.

### CROSS-REFERENCE To RELATED APPLICATIONS

This application claims the benefit of U.S. Provisional Patent Application No. 62/721,748 filed Aug. 23, 2018, the content of which is hereby incorporated by reference herein in its entirety. Various embodiments of the present disclosure may utilize one or more of the trading platforms, exchanges, order management systems (“OMS”), pricing algorithms, market mechanics, and other features of the following U.S. Patents and Applications: U.S. Pat. No. 8,566,213, issued Oct. 22, 2013; U.S. patent application Ser. No. 10/310,345 (U.S. Patent Publication No. 2004/0034591), U.S. patent application Ser. No. 12/477,549, U.S. patent application Ser. No. 12/470,431, U.S. patent application Ser. No. 12/135,479, U.S. patent application Ser. No. 12/113,602, and U.S. patent application Ser. No. 12/237,976. It should be understood that the features described herein may also be configured to operate within the trading systems described in U.S. patent application Ser. No. 12/477,549, filed Jun. 3, 2009, entitled “PRODUCTS AND PROCESSES FOR GENERATING A PLURALITY OF ORDERS,” U.S. patent application Ser. No. 12/470,431, filed May 21, 2009, U.S. patent application Ser. No. 12/135,479, entitled “TRADING SYSTEM PRODUCTS AND PROCESSES”, filed Jun. 9, 2008, U.S. patent application Ser. No. 12/113,602, filed May 1, 2008, entitled “ELECTRONIC SECURITIES MARKETPLACE HAVING INTEGRATION WITH ORDER MANAGEMENT SYSTEMS,” U.S. patent application Ser. No. 12/237,976, filed Sep. 25, 2008, entitled “TRADING RELATED TO FUND COMPOSITIONS”, U.S. patent application Ser. No. 12/113,642 filed May 1, 2008, U.S. patent application Ser. No. 12/257,499 filed Oct. 24, 2008, U.S. Ser. No. 13/888,352 filed May 6, 2013 (U.S. Patent Publication No. 2014/0229353), U.S. Ser. No. 13/844,779 filed Mar. 15, 2013, U.S. patent application Ser. No. 15/622,977 filed Jun. 14, 2017, U.S. Provisional Patent Application No. 62/444,711 filed Jan. 10, 2017 and U.S. Provisional Patent Application No. 62/445039 filed Jan. 11, 2017. The disclosures of these applications, patents, and publications, and all other documents referenced in this patent application, are incorporated by reference herein in their entireties.

### BACKGROUND

Various systems enable submission of trading orders. For example, U.S. patent application Ser. No. 10/310,345 (U.S. Patent Publication No. 2004/0034591), which is hereby incorporated herein by reference, describes a system that sends anonymous trading messages from one party to a targeted group of contra-parties.

### SUMMARY

In accordance with an aspect of the present disclosure, a method of operating a distributed trading platform may include controlling, by at least one processor: monitoring, over a communication network in real time, trading activity information indicating trading activities of respective second participants, in which the second participants are liquidity takers; determining in real time toxicity ratings respectively for the second participants, based on the trading activity information; receiving, over the communication network from a first participant system of a liquidity provider, a first order; automatically in response to receiving the first order and in real time, determining toxicity augments from the toxicity ratings respectively of the second participants, and transmitting, over the communication network, first order display information to second participant systems respectively of the second participants, to cause display on a graphical user interface (GUI) of a display of each second participant system of the second participant systems of an indication of the first order with the toxicity augment corresponding to the second participant; receiving, over the communication network from a given second participant system of the second participant systems, a contra order; in response to receiving the contra order, transmitting the contra order, over the communication network, to the first participant system; receiving, over the communication network from the first participant system, an indication that a quantity of a financial instrument indicated in the first order is reserved; and in response to receiving the indication that the quantity of the financial instrument is reserved, facilitating execution of an exchange that fulfills at least a part of each of the contra order and the first order.

In one alternative, a given toxicity augment for a given second participant of the second participants may be determined as a function of a given toxicity level corresponding to the given second participant.

In one alternative, a given toxicity augment for a given second participant of the second participants may be determined from a look-up table indicating given toxicity augments for respective toxicity levels.

In one alternative, the trading activities information may include real time market data received over the communication network from a remote market data provider.

In one alternative, a given toxicity augment of a given second participant of the second participants may be transmitted over the communication network as part of given display information to a given second participant system of the given second participant.

In one alternative, an amount equal to a sum of a given toxicity augment of a given second participant of the second participants and a price of the first order may be transmitted over the communication network as part of given display information to a given second participant system of the given second participant.

In one alternative, the indication may display the first order with the respective toxicity augment indicated separately from an indication of a price of the first order.

In one alternative, the indication may display the first order with the respective toxicity augment incorporated into an indication of a price of the first order.

In one alternative, the transmitting, over the communication network, the first order display information to the second participant systems may cause simultaneously displaying different toxicity augments with a price of the first order on the displays respectively of the second participant systems.

In one alternative, the method may further comprise controlling, by at least one processor, causing, over the communication network, display of a shot clock on the GUI of the display of at least one second participant system of the second participant systems to indicate a countdown of available time remaining for at least one second participant corresponding to the at least one second participant system to react to the first order.

In one alternative, the method may further comprise controlling, by at least one processor: automatically responsive to a determination that there is no time remaining for the at least one second participant to react to the first order, causing, over the communication network, refreshing of the display on the GUI such that (i) the shot clock indicates the available time is expired and (ii) an indication operable to request to execute a trade fulfilling the first order displayed on the GUI is replaced by an indication operable to request to refresh of the first order.

In one alternative, the method may further comprise controlling, by at least one processor: automatically responsive to a determination the indication to request to refresh the first order is operated and receiving an indication that a second quantity of the financial instrument indicated in the first order is reserved, facilitating execution of an exchange that fulfills at least a part of each of the contra order and the first order.

In one alternative, the method may further comprise controlling, by at least one processor: determining for given second participants of the second participants updated toxicity augments from the toxicity ratings respectively of the given second participants; and automatically responsive to determining the updated toxicity augments, transmitting, in real time over the communication network, the updated toxicity augments respectively to given second participant systems of the given second participants, to cause refreshing of the graphical user interface of each of the given second participant systems to display the updated toxicity augment instead of the toxicity augment respectively corresponding to the given second participant system.

In one alternative, the method may further comprise controlling, by at least one processor, determining whether the second participants are qualified to view the first order.

In one alternative, the method may further comprise controlling, by at least one processor, transmitting the first order display information, over the communication network, to cause display on the GUI of each of the second participant systems indicia as a button operable to accept the first order with the toxicity augment.

In one alternative, the method may further comprise controlling, by at least one processor, securely storing, in a database, trading intentions of the liquidity provider received over the communication network from the first participant system.

In one alternative, the trading intentions may be encrypted as received over the communication network, and in which the at least one processor may control: decrypting the trading intentions; and storing the trading intentions in decrypted form in the database.

In one alternative, the first order display information may be transmitted encrypted respectively to the second participant systems.

In accordance with an aspect of the present disclosure, a distributed trading system may include: a first participant system of a liquidity provider, in which the first participant system includes a first computing device configured to control: identifying a first order for distributed order matching entered at a trader interface of the first participant system, and transmitting, over a communication network, the first order to a central system of the distributed trading system; and the central system comprising a second computing device configured to control: monitoring, over the communication network in real time, trading activity information indicating trading activities of respective second participants, in which the second participants are liquidity takers; determining in real time toxicity ratings respectively for the second participants, based on the trading activity information; receiving, over the communication network from the first participant system, the first order; and automatically in response to receiving the first order and in real time, determining toxicity augments from the toxicity ratings respectively of the second participants, and transmitting, over the communication network, first order display information to second participant systems respectively of the second participants, to cause display on a graphical user interface of a display of each second participant system of the second participant systems of an indication of the first order with the toxicity augment corresponding to the second participant; receiving, over the communication network from a given second participant system of the second participant systems, a contra order; in response to receiving the contra order, transmitting the contra order, over the communication network, to the first participant system; receiving, over the communication network from the first participant system, an indication that a quantity of a financial instrument indicated in the first order is reserved; and in response to receiving the indication that the quantity of the financial instrument is reserved, facilitating execution of an exchange that fulfills at least a part of each of the contra order and the first order, in which the first computing device is configured to control: receiving, over the communication network, the contra order; and transmitting, over the communication network, the indication that the quantity of the financial instrument indicated in the first order is reserved.

In one alternative, the trading system may further include the second participant systems, in which each of the second participant systems includes a third computing device configured to control: receiving, over the communication network, the first order display information; rendering on the graphical user interface the indication of the first order with the toxicity augment corresponding to the second participant; and transmitting, over the communication network, a given contra order.

### BRIEF DESCRIPTION OF THE DRAWINGS

FIG. 1 depicts a system according to at least one embodiment of the systems disclosed herein;

FIG. 2 depicts a flow diagram according to at least one embodiment of the methods disclosed herein; and

FIG. 3 depicts a popup element that may be part of a graphical user interface in some embodiments.

FIG. 4 depicts another popup element that may be part of a graphical user interface in some embodiments.

### DETAILED DESCRIPTION

Various embodiments are directed to a trading network and/or interface. In some embodiments, a distributed system interacts with one or more order management systems to determine available orders for a first one or more participants. In some embodiments, the distributed system interacts with order management systems to determine which of the available orders to solicit matches from a second plurality of participants. Various embodiments improve the speed, efficiency and usability of traditional trading systems and traditional trading interfaces.

In one exemplary embodiment, a memory stores instructions which, when executed, may direct at least one processor to perform various actions. The processor may receive information about a first order in an order management system (OMS) of a market participant. The processor may search for matches to the first order in an attempt to work or fulfill the first order for the market participant by causing the first order to be displayed to respective second market participants based on the contents of the second market participants' order management systems. In response to matching, the processor may attempt to reserve orders in an OMS and/or execute a trade.

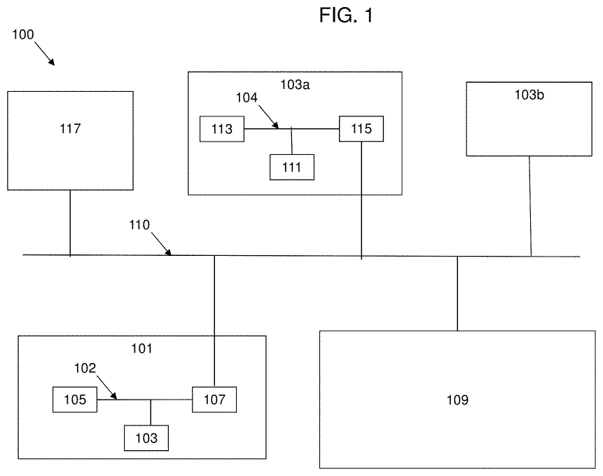

Some embodiments may include systems and methods for interacting with order management systems and/or execution management systems of market participants to facilitate targeted order matching. FIG. 1 depicts a system according to at least one such embodiment. It should be recognized that the elements and arrangement of this depicted system are given as an illustration only. Other embodiments may include more, fewer, different, differently arranged, and so on elements.

The distributed system 100 of FIG. 1 includes a first participant 101. In some embodiments, a first participant may include a buy side entity. A first participant may have a set of trading desires (e.g., a desire to buy and/or sell a variety of financial instruments in pursuit of a trading strategy).

Such trading intentions may generally be held securely in an order management system of the first participant. FIG. 1 illustrates a first participant including an order management system 103. In some embodiments, such a system 103 may be or may include an execution management system (EMS). Order management systems and execution management systems are known in the art and may be used interchangeably for the purposes of this disclosure. Some example of OMSes/EMSes may include the Fidessa order management system, the Charles River OMS and the Bloomberg execution management system. An OMS may track order status, allow reservation of orders, allow reading of orders, allow orders to be canceled, allow orders to be marked as fulfilled, allow entry of new orders, and so on.

Such an order management system may include an application programing interface (API) that presents read, write, and/or modify capabilities to the OMS for authorized systems. A trader using a trader interface may be authorized to enter, receive and/or modify information in the OMS. A first participant system 107 may be authorized to enter, receive and/or modify information in the OMS. The OMS may receive instructions through the API and respond to the instructions to enable such reading, writing, and/or modifying.

In some embodiments, such an OMS may receive order intentions for a first participant (e.g., through a trader interface 105), communicate orders to a first participant system 107, receive a request to reserve liquidity for an order, attempt to firm up liquidity by canceling sufficient reserved liquidity elsewhere (e.g., in other trading venues or with other brokers that are working an order in an OMS), report to a first participant system results of firming up liquidity, receive a modification of liquidity for an order, and/or modify orders to reflect fulfilled liquidity.

A first participant may include one or more trader interfaces. An example of such a trader interface is indicated at 105. Such an interface may include a workstation of a trader that may enter and/or engage with a trading intention stored in the OMS 103 and/or orders being worked through the distributed system or elsewhere using a graphical user interface. In some embodiments, a trader interface may be used to enter an aggression level, to enable matching of orders through the distributed system, to interact with prompts from the distributed system and/or to manage trading through the order management system. A first participant may include numerous trader interfaces in some implementations.

A first participant may include a first participant system 107 that interfaces the first participant with a central system 109 of the distributed system. For example, the first participant system may interact with an OMS to read information about orders that is encrypted and then transmit the encrypted orders information to the central system, which decrypts the encrypted orders information and stores the decrypted orders information in a database of the central system. As another example, the first participant system may interact with an OMS to reserve orders, identify that orders are filled, or otherwise write or modify information in the OMS. To facilitate such interaction, the OMS may communicate with an API of the OMS and/or snoop and analyze packet transmission to and/or from the OMS. A first participant system may read orders from an OMS, transmit those orders to a central system for attempted order matching, receive information that a match fulfilling at least a part of the order has been found through the central system, attempt to reserve liquidity in the OMS in response to receiving the match, notify the OMS whether the liquidity has been reserved successfully, receive an indication of order execution through the central system, and modify the OMS to indicate that the at least the portion of the part of the order has been fulfilled.

In some embodiments, a first participant system may interact with a trader interface 105 to control the trader interface to present information or solicit input. In some embodiments, a first participant system may control a trader interface to display an indication of order fulfillment in response to an execution of an order based on an order in an OMS.

In some embodiments, a first participant system may interact with a central system 109. For example, a first participant system may send the central system information about responses to prompts input through the trader interface, and information about orders and/or reservations in an OMS, and may receive information about order fulfillment and/or requests for reservation from the OMS.

The identified components of a first participant may include computing devices such as processors, workstations, blades, servers, displays and so on. The identified components may include software and/or hardware modules that may perform functions discussed herein. Components of first participant 101 may interact with each other through a network of first participant 101. Such a network is indicated at 102. In some embodiments, such a network may include a LAN or other local real or virtual network with wired and/or wireless components. Communication between elements may take place using a FIX or other protocol. Communication may include encrypted communication that keeps trading intention secure.

Some embodiments may include a central system 109. Such a central system may include an order matching system that receives orders from a party (e.g., a first participant) and attempts to facilitate execution of trades that fulfill the orders (e.g., against matching contra orders of a second participant). Execution may be performed through an electronic clearinghouse that may be remote from the central system in some embodiments. Central system may receive first orders from a first participant (e.g., from a first participant system that reads orders from an OMS of the first participant). The central system may then distribute the first orders to a plurality of second participants by communicating with second participants (e.g., second participant systems) in an attempt to fill the first orders of the first participant. In response to determining a match for a first order (e.g., receiving an indication from a second participant system of a second participant that a firm order has been placed by the second participant matching one of the first order), if the first order is still available, the central system may reserve or firm up trading intentions sufficient to fulfill a contra order with the first participant (e.g., by communicating with a first participant system of the first participant), fulfill the orders if sufficient liquidity is successfully reserved (e.g., using a clearinghouse to execute a trader, in response to receiving an indication of successful reservation by the first participant system of the first participant), and notify the first participant and second participant (e.g., by communication to respective participant system) of execution.

The central system 109 may comprise a computer, server, hub, central processor, memory and/or other entity in a distributed trading network. The central system 109 may comprise input and output devices for communicating with other various system 100 elements (e.g., network interfaces). In some embodiments, the central system 109 may comprise a trading platform, an exchange, or other order processing system. The central system may communicate with another system using a network 110. The network may include a public or private network. The network may include wired or wireless elements. The network may include the Internet. Communication may include encrypted communication that keeps trading intentions secure. The communication may use the FIX protocol in some implementations.

The distributed system of FIG. 1 may include a second participant. The system shown includes two second participants 103a and 103b. Second participant 103a is shown in detail. Second participant 103b may include a similar or different structure. There may be any number of such second participants in various embodiments.

A second participant, like a first participant, may have a set of trading desires (e.g., a desire to buy and/or sell a variety of financial instruments to follow a trading strategy). Such trading intentions may generally be held securely in an order management system of the second participant. FIG. 1 illustrates a second participant 103a including an order management system 111.

Such an order management system may include an API that presents read, write, and/or modify capabilities to the OMS for authorized systems. A trader using a trader interface may be authorized to enter, receive and/or modify information in the OMS. A second participant system 115 may be authorized to enter, receive and/or modify information in the OMS. The OMS may receive instructions through the API and respond to the instructions to enable such reading, writing, and/or modifying.

In some embodiments, such an OMS may receive order intentions for a second participant (e.g., through a trader interface 113), communicate orders to a second participant system 115, receive an indication to reserve liquidity (e.g., from a trader interface and/or second participant system for a trade that a trader has accepted), report to a second participant system results of firming up liquidity, receive a modification of liquidity for an order, and/or modify orders to reflect fulfilled liquidity.

A second participant may include one or more trader interfaces. An example of such a trader interface is indicated at 113. Such an interface may include a workstation of a trader that may enter and/or engage with a trading intention stored in the OMS 111 and orders being worked through the distributed system or elsewhere using a graphical user interface. In some embodiments, a trader interface 113 may be used to receive and respond to trade prompts from a second participant system, and/or to manage trading through the order management system. A second participant may include numerous trader interfaces in some implementations.

A second participant may include a second participant system 115 that interfaces the second participant with the central system 109. The second participant system may perform interfacing between the second participant and a central system 109. For example, the second participant system may interact with an OMS to read information about orders that may be used by the participant system to filter orders. As another example, the second participant system may interact with an OMS to reserve orders, identify that orders are filled, or otherwise write or modify information in the OMS. To facilitate such interaction, the OMS may communicate with an API of the OMS and/or snoop and analyze packet transmission to and/or from the OMS.

A second participant system may interact with a central system and a trader interface and an OMS. For example, in some embodiments, such a second participant system may read orders from an OMS, receive a first order from a central system, filter the first order based on the orders read from the second participant's OMS, present the first order through the trader interface of the second participant, receive a firm order from the second participant matching the first order, reserve the liquidity for the firm order in the OMS of the second participant in response to receiving the firm order, transmit the firm order to the central system in response to reserving the liquidity and/or receiving the firm order, receive an indication that the firm order has been fulfilled from the central system, and modify the OMS of the second participant to indicate that the firm order has been fulfilled in response to receiving the indication that the firm order has been fulfilled.

The identified components of a second participant may include computing devices such as processors, workstations, blades, servers, displays and so on. The identified components may include software and/or hardware modules that may perform functions discussed herein. Components of second participant 103a may interact with each other through a network of second participant 103a. Such a network is indicated at 104. In some embodiments, such a network may include a LAN or other local real or virtual network with wired and/or wireless components. Communication between elements may take place using a FIX or other protocol. Communication may include encrypted communication that keeps trading intention secure.

In some embodiments, components of a central system, second participant and/or first participant may operate behind a firewall such that users may not view or obtain the information behind the firewall. For example, information about a first order in an OMS of a first participant may be communicated at least partially encrypted to a second participant system of a second participant, such that the second participant and other users outside the system may be unable to view and/or access at least some of that information (e.g., first order for which the second participant is not qualified to see). In some embodiments, a specific first order that the second participant is not qualified to see may be communicated in a message with encryption, and the second participant may not have information necessary to decrypt the specific first order from the message but can view a specific second order which is also included in the message without encryption or with encryption that the second participant can decrypt.

Some embodiments may include a data provider 117 that may provide information regarding financial instruments. Such information may be provided in real time, over the network 110, as information is created or as it first becomes available to the general public, or at another time. Data provider 117 may provide such information in any one or more of a variety of forms and means such as video, audio (e.g., radio broadcast), text (e.g., stock ticker-type information), or other data that may convey information. Data may be provided at a variety of different timings. In some embodiments, data may be provided periodically or continuously, e.g., via a data feed (e.g., a stream of data that includes real time updates of trading-related information). In some embodiments, data may be provided after an event, e.g., a trade or submission of an order. In some embodiments, data provider 117 may provide to central system 109 trading-related information. In some embodiments, a central system may distribute such information to elements of the distributed system.

It should be recognized that the various elements of system 100 are given as non-limiting examples only. Each component, element of a component and/or functionality of such elements and/or components shown or described may be different, the same, or absent in various embodiments. For example, in some embodiments, there may be multiple first participants, a single second participant, and/or a remote electronic clearinghouse that communicates with a central system through a communication network to execute orders matching one of a plurality of first orders. As another example, in some embodiments, a system may communicate with remote trading venues to enable compliance with a Regulation National Market System (NMS).

Distributed system 100 may operate to enable a fast, efficient, secure and usable trading environment that improves on liquidity distribution, interface clutter and computer resource usage over traditional trading systems. Trading intentions that would otherwise have stayed private may become available and be securely distributed with encryption to targeted parties as targeted participants. In some embodiments, the trading intentions may be encrypted and provided simultaneously to multiple targeted participants over a communication network, where encrypted trading information is selectively prepared according to predetermined toxicity characteristics of selected targeted participants and then distributed to the selected targeted participants. The present disclosure thus provides technical advantages that constitute technical solutions to technical problems, in that the present disclosure may spread trading information more broadly, limit information leakage by preventing spread of information out of natural contra parties that constitute selected targeted participants, limit bandwidth usage by limiting transmissions within a participant to highly relevant orders, limit interface cluttering by limiting order presentation to only highly relevant orders, and create a more optimal distribution of capital resources in a short amount of time.

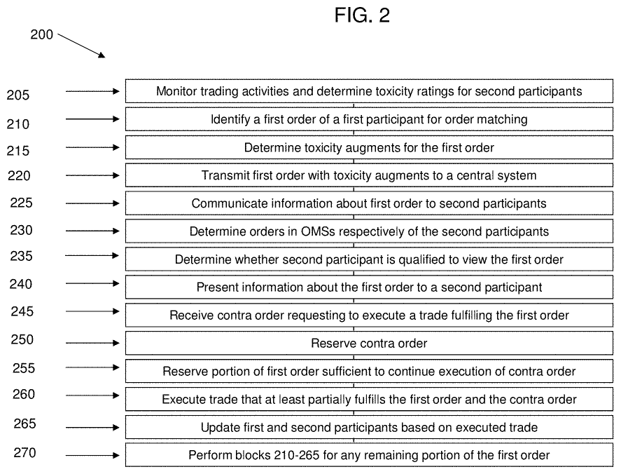

Some embodiments may include a method. Such a method may be performed by a distributed system that includes components such as one or more of the components of distributed system 100. FIG. 2 depicts a flow diagram 200 according to at least one embodiment of the functionality of such a distributed system.

It should be understood that each function(s) described for each block may be performed using one or more computer components capable of performing that function. It should also be appreciated that the acts described in these blocks may be performed in any order (including but not limited to the exemplary orderings shown on the diagram), not all blocks need be performed and that some blocks may be performed together, simultaneously and/or as a single act.

In block 205, the system 100 (e.g., central system 109) may monitor trading activities of participants and determine toxicity ratings for the participants based on the trading activity. Monitoring trading activity may include monitoring trading activity occurring on the distributed system 100 and/or monitoring trading activity in a broader market (e.g., through public data and/or information from other trading venues). Monitoring trading activity may include monitoring the effects that a trade with a particular participant has on the market price for a financial instrument involved in the trade (e.g., receiving market data from a data source). Toxicity may refer to the impact of such a trade has to the market price for a financial instrument against the contra party to the trade.

In some embodiments, the system may enter second participants into one of a plurality of toxicity levels or groups, based on the toxicity ratings. For example, there may include a low toxicity group, a medium toxicity group and a high toxicity group. Determining toxicity ratings may include adding each participant to one of the groups.

One example of a toxicity measurement may be based on trading activity through the system 100 over a last year (or more or less time, weighted so that more recent activity matters more). In one example, performance of financial instruments ten seconds prior to the trade and various of points of time up to thirty minutes after a trade may be determined. A determination may be made regarding how much the price moved before and after a trade. If, for example, after a purchase of a financial instrument, financial instruments routinely go up in price for a second participant, that second participant may have a positive toxicity level. On the other hand, for a particular trade, if a second participant bought a financial instrument and the price went down after the purchase, that trade may have a negative toxicity level for the second participant. In some embodiment, toxicity levels over all of the trades in a period of time may be averaged (e.g., weighted average based on time and/or quantity, straight average, etc.). If for a particular second participant, prices always go up after a purchase by the second participant, for example, then that second participant may be considered an expensive participant to trade with and have high toxicity.

Toxicity levels may be on an absolute basis and/or a hedged basis. For example, a toxicity level may be relative to how the S&P 500 moved during a monitoring period (or some other index). If a stock outperforms the S&P during a monitoring period, then there may be toxicity even if the price in absolute terms decreased (e.g., decreased but not as much as the S&P in that time period).

In some embodiments, a toxicity level may be expressed in terms of a spread (e.g. between a best bid and best offer for a financial instrument). For example, a toxicity level may be expressed as multiple of a spread. Through normal trading, one might expect about one half spread worth of toxicity. A toxicity in that range (and/or up to 1 spread) may be considered no or low toxicity. In some embodiments, twice the spread may be considered a high toxicity. In some embodiments between 1 spread and twice the spread may be considered a medium toxicity. It should be recognized that such examples of toxicity levels for groups is given as an example only and that other embodiments may include other groups and/or levels.

In some embodiments, second participants may be notified of their toxicity ratings. A second participant system may receive a toxicity level indicator, store it, and use it later for order filtering and/or display. In some embodiments, a first participant system or second participant system, or the central system, may receive a toxicity level indicator for a specific second participant as encrypted data, decrypt the encrypted toxicity level indicator, store the decrypted toxicity level indicator, and use the decrypted toxicity level indicator later for order filtering and/or display. In some embodiments, toxicity ratings for each second participant may be kept confidential with that second participant so that other second participants may not know each other's toxicity levels.

Trading may be monitored over time and toxicity levels may be updated based on new information (e.g., continually, daily, periodically, automatically in response to a trade, etc.).

In a traditional trading system, a high toxicity participant may be avoided. This may decrease the liquidity and efficiency in a market. System 100 may enable trading to occur despite toxicity, thereby advantageously increasing the speed, usability and efficiency of the trading system of the present disclosure compared to traditional systems.

In block 210, the system 100 (e.g., participant system 107) may identify a first order (e.g., in an order management system 103) of a first participant 101 that is designated for distributed order matching through the system 100. This identification may be performed by reading information from an order management system through an API, packet capturing of transmissions made to and/or from an OMS 103, from a communication from trader interface 105 selecting the order for submission to the distributed system, and/or through another method or responsive to another input. In some embodiments, a trader interface may be used to designate specific orders in the OMS for order matching through the distributed system. The first order may include an order to buy or sell a quantity of a financial instrument (e.g. stock, bond, derivative, etc.). For example, the first order may be an order to sell 20,000 shares of GOOGLE stock at market price. For the purposes of this example, the current market price may be assumed to be S141.

In block 215, the system 100 (e.g., first participant system 107) may determine toxicity augments for the first order. A toxicity augment may include a price change from an order price or market price that is to be applied based on a toxicity level of a contra party. A toxicity augment may be determined in a number of ways. For example, a user may enter a toxicity augment for a first order through a trader interface, an order management system may store and provide toxicity augments, a universal toxicity augment may be applied to all orders or all orders from a first participant, a trader may set toxicity augments based on order parameters, a toxicity augment may be determined as a function of a level toxicity of a specific second participant or a specific trader that may trade through a trader interface of a second participant, and so on. Toxicity augment may indicate, for example, a price change to be applied to different levels of contra party toxicity (e.g., a non-toxic contra party has no augment applied, a low level toxicity has a small augment applied, and a high level toxicity has a large augment applied). In one embodiment, one or more look-up tables may be configured in a memory of the system 100 (e.g., first participant system 107) to store toxicity augments cross-referenced with respective levels of toxicity, and also levels of toxicity cross-referenced with respective participants as contra parties, where the system 100 may retrieve, using the table, a specific toxicity augment for a specific potential contra party according to a specific toxicity level of the specific potential contra party as a second participant.

In block 220, the system 100 may cause the first order and/or toxicity augments to be transmitted to and received by central system 109. This may be performed in response to identifying the first order and/or determining toxicity augments. In this way, the central system becomes aware of information that is hidden securely from the public in what may be an otherwise dark pool of liquidity that is stored securely in the first participant's order management system. The central system may then be able to use this information to search for order matches hidden in other dark pools of liquidity in second participants' OMSes.

In block 225, information about the first order may be communicated to second participants by system 100. The order may be transmitted from the central system to respective second participant systems at each of a plurality of second participants. The second participant systems may receive the order. In some embodiments, transmitting the order may include transmitting the toxicity augments for the order.

In block 230, the system 100 (e.g., second participant system 115) may determine orders in the OMS of a second participant. This may be done for each second participant that is a participant in the distributed system 100. These orders may be determined by reading information from an order management system through an API, packet capturing of transmissions made to and/or from an OMS 111, from a communication from trader interface 113 selecting the order for submission to the distributed system, and/or through another method or responsive to another input. In some embodiments, a trader interface may be used to designate specific orders in the OMS for order matching through the distributed system.

In block 235, the system 100 (e.g., second participant system 115) may determine whether the second participant is qualified to view a first order. Each second participant system of each second participant may perform a similar determination.

In some embodiments, determining whether the second participant is qualified to view an order may include determining whether the second participant has a contra order to a first order in its order management system by referencing the received information from block 225. If there is a contra order to match against a first order then the second participant may be determined to be qualified to view a first order.

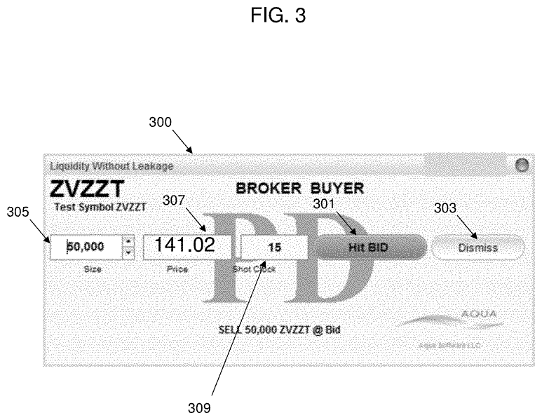

In block 240, the system 100 (e.g., second participant system 115 and/or trader interface 113) may present information about the first order to the second participant (e.g., to a trader using the trader interface 113). This information may be displayed through a graphical user interface at the trader interface. A popup or prompt may ask for the second participant to enter into a firm order fulfilling at least part of the first order. FIG. 3 illustrates an example popup interface that may be used in some embodiments. This provides an efficient, secure and usable interface experience for the second participant that enables a highly informed and quick interaction with the distributed trading system.

In some embodiments, presentation of information may be performed at each of the second participants that qualify to view a first order.

Some embodiments may include determining which of the toxicity augments to apply to the order. For example, the first order along with its toxicity augments may be received by the second participant system. In some embodiment, a toxicity augment may be provided to the second participant system as an amount to be summed with a price of the first order, where the toxicity augment is provided in the same, or separately from, a communication message including a price of the first order. In some embodiments, an amount equal to the sum of the toxicity augment and a price of the first order may be provided to the second participant system.

In some embodiments, the second participant system may determine in which toxicity level the second participant is currently. Using the determined toxicity level and the toxicity augment, which may be determined from a table in memory or as a function of toxicity level as discussed above, the second participant system may apply the appropriate toxicity augment (e.g., the toxicity augment for the toxicity level of the participant) to the order price to determine what price to present for the order. Second participant system adds a premium based on participant class to what is presented to the second participant.

In some embodiments, a pop-up window (e.g., graphical user interface 300) may prompt the qualifying trader to trade or dismiss the order through trader interfaces 113. For example, a pop-up window may display an option to engage the offer such as button 301. This may be an option to hit the bid (as in the example) or lift an offer depending on the side of the trade of the first order in the OMS of the first participant. The pop-up window may display an option to dismiss the offer such as button 303. The popup window may include an option to adjust a size such as size interface 305. The popup window may include an indication of a price 307 (e.g., the price with the toxicity augment applied).

In some embodiments, the central system 109 may monitor in real time, over one or more of the network 110 and a communication network external to the system 100, trading activities of second participants of the system 100 based on at least one of trading activity information received in real time from the data provider 117 or real time trading activity occurring on the system 100. The central system 109 may determine different toxicity levels for respective second participants in real time based on the real time monitoring of trading activities, and automatically update dynamically and in real time toxicity augments to be applied to an order for respective second participants and automatically cause in real time refreshing of a GUI on a display to present the first order with the updated toxicity augment in place of the first order with a previously determined toxicity augment.

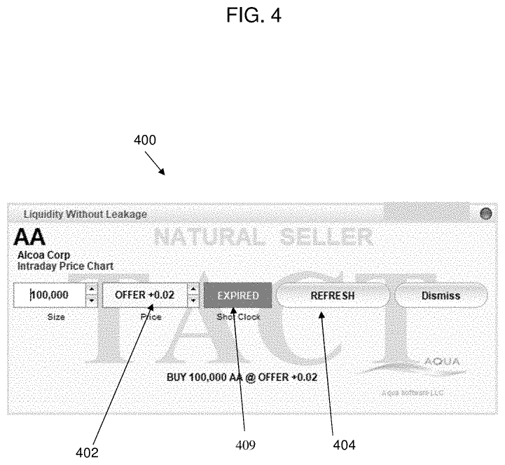

In another embodiment, referring to FIG. 4, a popup window (e,g., a graphical user interface 400) may display an indication of a price 402 with an indication of amount of the toxicity augment (e.g., +0.02) applied to a price of the offer, which may be displayed on a same or different display that displays the GUI 400.

In some embodiments where price is tied to a market price (e.g., a midpoint of a best bid or offer), the price may be continually updated as the market price fluctuates. In other embodiments, referring to FIG. 3, the price including a toxicity augment may stay stable for some period of time indicated on a shot clock interface 309, which may indicate time that is available for the second participant to react to the offer (e.g., 15 seconds). In still other embodiments, the price including a toxicity augment may be expressed as an offset from the market price that may be stable and/or may be in real time automatically and dynamically adjusted according to market conditions depending on the embodiment. In still other embodiments, the price including a toxicity augment may be expressed as an offset from the market price that may be, in real time, automatically and dynamically adjusted according to changes to a toxicity augment that may be based on one or more of real time market conditions and real time trading activities information concerning a second participant.

In block 245, the system (e.g., second participant system 115, trader interface 113 and/or central system 109) may receive a request to execute a trade fulfilling at least a part of the first order from the second participant. For example, the second participant may operate a graphical user interface of the trader interface to indicate acceptance of an offer. Information may be transmitted to the second participant system from the trader interface identifying the request.

In block 250, the system (e.g., second participant system 115, trader interface 113 and/or central system 109), responsive to receiving the request to execute the trade, may reserve the contra order in the second participant's OMS. This reservation may be performed by communicating a request to reserve from the second participant system or from the trader interface to the second participant's OMS. This action of reserving the contra order makes the contra order a firm order and prevents other trading venues or brokers from acting on the contra order while it is reserved.

Receiving a request to execute a trade and reserving liquidity with a second participant's OMS may take place in a variety of manners. For example, in some implementations, a request to execute a trade may be transmitted to and received by a central system (e.g., from a trader interface to a second participant system and then to a central system). The central system may determine that the first order is still available (e.g., that it has not been taken by another higher time priority contra order). In response to such a determination, the central system may request that liquidity be reserved, through the second participant system and the OMS of the second participant. If the central system determines that the first order is not available, the central system may notify the second participant system and no reservation of liquidity may occur.

As another example, a reservation of liquidity may be performed before a central system is notified of the order. A second participant system may receive the request from the trader interface and in response reserve the liquidity with the OMS. In response to reserving the liquidity, the second participant system may notify the central system of the order. The central system may then determine whether the first order is still available. If the first order is still available, the method may continue. If the first order is not available (has been matched elsewhere and/or been canceled) then the central server may release the reserved liquidity with the second participant (e.g., through communication with the second participant system 115).

In block 255, responsive to reserving the contra order in the second participant's OMS, the system 100 may attempt to reserve liquidity sufficient to fulfill the contra order in the first participant's OMS. For example, a second participant system 115 may receive an indication that the second participant accepted an offer to engage with a first order and that the contra order is reserved in the second participant's OMS. In response, the second participant system may transmit such information to the central system. The central system may receive the information from the second participant system of the second participant. If the first order is still valid, the central system may in response to receiving the information, transmit the information to the first participant system of the first participant to request reservation of shares to fulfill the contra order. The first participant system 107 may receive that information, and in response, the first participant system 107 may communicate with the first participant's order management system 103 asking that the number of shares (e.g., 16000 shares of GOOGLE) be reserved for execution through central system.

It should be appreciated that the first participant may be shopping all or a portion of first order elsewhere, and that the first order may be cancelled or filled elsewhere during the process described herein. If the first order has already been executed elsewhere or cancelled, then the liquidity may not be available in the first participant's OMS to fulfill the contra order. In such a case the trade may be cancelled and the contra order's reservation in the second participant's OMS may be released. In some implementations, there may be a minimum fill percentage that is less than 100% that may still allow the contra order to continue despite insufficient liquidity (e.g., 90%).

In some embodiments, a portion of a first order may be reserved by another entity when a request for reservation is received by the first participant (e.g., first participant OMS). In such an instance, the first participant may attempt to firm up the liquidity sufficient to fulfill the contra order. Such a firming up may include canceling reservations with other trading venues and/or brokers that have not yet completed trades. If the first participant is able to firm up sufficient liquidity, then the first participant's OMS may reserve the shares for the contra order. In response to receiving a request to reserve, the OMS may transmit cancelation messages to remote trading partners that have reserved liquidity with the OMS to firm up sufficient liquidity.

If the first participant's OMS reflects sufficient liquidity or the first participant is able to firm up sufficient liquidity, the OMS may reserve the shares and notify the first participant system 107 that the share have been reserved. In some embodiments, shares may be reserved in an OMS for some limited period of time. After that time period passes, the shares may be released by the OMS. In other embodiments, the shares may be reserved until actively released by the entity reserving the shares.

In block 260, responsive to reserving the liquidity in the first participant's OMS, the system 100 may facilitate execution of a trade fulfilling at least part of each of the first order and the contra order. In response to receiving information indicating that liquidity has been reserved by the OMS 103, the first participant system 107 may communicate with central system 109 that the liquidity is reserved. In response to receiving such information, the central system may take actions to execute the trade. For example, the central system may communicate with a remote electronic clearinghouse to execute the trade.

The price of the trade may be the price of the first order with a toxicity augmentation applied that matches a contra party's toxicity level. Referring to FIGS. 3 and 4, a trader interface may be populated with this information at a second participant system in response to determining the toxicity level and that the second participant is qualified to view the first order. In this way, in some embodiments, a single first order may have the ability to be matched against a contra orders with different prices displayed to different contra parties. An order identifier may be used to track incoming contra orders so that the central system can determine that the contra order is matched against a particular first order despite the price possibly being different because of a toxicity augmentation.

In some embodiments, if a price of a trade is outside of a NBBO spread, then the central system may communicate with remote trading venues so that orders at protected venues of Reg NMS for better prices are included in a trade. In this instance, the trade that is executed with the clearinghouse may not be for the total quantity agreed upon. For example, a central system may receive market data indicating that there are orders at better prices than a matched price at one or more remote protected trading venues. The system may communicate with those venues so that the orders there are matched against, prior to matching between the first order and the contra order. This may leave some amount of size left in the first order and contra order which is equal to the first order size or contra order minus orders at the protected venues for better prices. This remaining order size may be executed to fill the rest of the first order and contra order. In this way, one of the first order and contra order may be filled completely and the other may be partially filled (missing the protect order liquidity). In some instances, where the first order is for only a portion of the liquidity in an OMS of a first participant and part of the first order is filled with orders at a protected venue, the remaining liquidity at the first participant may be used to fill the remaining part of the contra order. In some embodiments, no trade may occur if there is not at least some minimum fill amount for each order (e.g., 90%).

In block 265, in response to executing the trade, the system may modify contents of the first participant's OMS and the second participant's OMS. For example, the central system may determine that a trade has been executed (e.g., based on information received from a remote electronic clearinghouse) with particular parameters (e.g., price, quantity, time). In response to receiving that information, the central system may communicate the information to each of first participant system 107 and second participant system 115. The first participant system may receive the information and modify the contents of the first participant's OMS in response to reflect to information (e.g., using an API to identify the trade has been executed in the OMS). The second participant system may receive the information and modify the contents of the second participant's OMS in response to reflect to information (e.g., using an API to identify the trade has been executed in the OMS).

In block 270, a subsequent first order may be worked through the system for remaining liquidity in the first participant's OMS. For example, executing the trade may have fulfilled a part of the ordinarily pending first order in the first participant's OMS. There may still be a pending order for the same financial instrument in the first participant's OMS (e.g., with a lower total quantity). The remaining liquidity may be worked by the distributed system. This working may be similar to that of the process described herein.

Some embodiments may maintain anonymity of participants from one another. A party's identity may be kept hidden form a contra party. In this manner information leakage, may be further reduced.

It is recognized that modern market participants use incredibly complicated algorithms and data processing techniques to develop and implement trading strategies. These algorithms are executed by some of the most advanced computers in the world. But, even those computers are limited by finite resources. Reducing the amount of data needed to process trading strategies may improve the functionality of these machines and expand the impact of these finite computational resources. By selectively transmitting a trade order with toxicity augment only to approved target participants, the amount of data processed and transmitted to execute a trade may be reduced. This may reduce the processing time, storage needs, and other computational resources (e.g., power, bandwidth, etc.) used to process and implement trading strategies. Selective transmission of the trade order with a corresponding toxicity augment may create a more usable and efficiently operating market.

In some embodiments, referring to FIG. 4, automatically responsive to when the time available to react to an offer expires, a shot clock interface 409 on the presentation of the GUI 400 may be refreshed to switch from presenting a remaining time for a first offer, e.g., 1 second, to presenting “EXPIRED” or the like to indicate that the time available to react to the first offer has expired. In some embodiments, a trader may operate the GUI 400 to indicate a desire to trade, by clicking a refresh button 404 on the GUI 400. Automatically responsive to the refresh button being operated, the first participant (or the central system) may determine if the first order or a portion thereof remains available, and if yes, a trade for the first order or a remaining portion thereof available may be executed, similarly as described above for the embodiment where the request to execute the trade is made before the shot clock expires. In some embodiments, the shot clock interface 309 may be presented to the second participant through an interface as a real time counting down clock. In some implementations, an indication that the end of the time period is reached may be sent to the second participant (e.g., in addition to the time period, instead of the time period, by changing a color, by playing a tone, through an interface, and so on).

In some embodiments, an indication of an amount of time remaining to execute a trade on the first order may be transmitted to one or more second participants. In some implementations, an indication that the time period has ended may be shown to the one or more second participants. In some embodiments, a time period to execute the first order shown on the GUI using a shot down clock may be different for second participants, in accordance with their respective different toxicity levels.

The above description is included to illustrate the operation of a non-limiting example and is not meant to limit the scope of the present disclosure. From the above discussion, many variations will be apparent to one skilled in the relevant art that would yet be encompassed by the spirit and scope of the present disclosure.

For example, although examples are given in terms of a central system, it should be recognized that other embodiments may not include such a central system. For example, one or more participant systems may perform one or more functions of the central system in some implementations. Other implementations may not include participant systems or a central system but rather OMSes may perform the role of both elements. In yet another example, roles described as part of a participant system may be performed by a central system, an OMS or the other party's participant system. For example, order filtering in accordance with approved second participants for a first participant and toxicity level of the approved second participants may be performed by a central system in some implementations where a central system maintains order information from OMSes of participants rather than participant systems.

As another example, some embodiments may perform price augmentation for toxicity at the central system rather than at the participant system. So, a single augmented order may be transmitted to each second participant. That single order may differ by second participant based on the second participant's toxicity level. The central system may track the toxicity level of each second participant and selectively apply augmentations before simultaneously transmitting orders to the respective second participants.

Therefore, the present disclosure provides improvements to computer and computer networks by simultaneously permitting multiple targeted parties as second participants to, in real time, be presented with trade information including respective toxicity augments on a respective GUI of a display, together with real time information for acting to execute a presented trade. Such improvements of the present disclosure are rooted in network and computer technology and overcome a technical problem specifically arising in the realm of computer networks and computers. Furthermore, the present disclosure provides an improved graphical user interface, which may increase the efficiency of using electronic computing devices at participants. In addition, the central system advantageously may control secure encrypted communications over a communication network with different trading parties at different remote locations who do not want their trading intentions revealed to the other participants, to provide for real time secure presentation of selected trade information on GUIs of second participant systems and real time secure exchange of trade related information via the central system, automatically responsive to actions taken at the respective second participant systems via GUIs thereof. Accordingly, the present disclosure discloses solutions to a problem in the software arts that arises in the realm of computer networking. The disclosed GUI solutions improve the functioning of technology by improving the accuracy of trader transactions.

As another example, the central system may include separate order books for each level of toxicity. A first order may be copied into each order book with a toxicity level applied. The central system may link the orders across the order books. When one of the orders is filled, that filled order may apply to all of the orders across the multiple order books.

As another example, the first order may be submitted to the system 100 as a firm order. In such an example, the liquidity may be reserved in an OMS upon submission. Accordingly, there may not be a need to reserve liquidity with the first participant after finding a match with the second participant.

As still another example, although some embodiments have been described with respect to system 100 and access to dark pools or OMSes, other embodiments may apply more generally to trading environments that do not include dark pools or OMS access. For example, a system such as the Fenics UST or Aqua trading system may utilize toxicity augmentation for its participants.

It will be readily apparent to one of ordinary skill in the art that the various processes described herein may be implemented by, e.g., appropriately programmed special purpose computers and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A processor may include one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

A computer-readable medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate automatically without any user intervention. In another embodiment, the process includes some human intervention (e.g., a step is performed by or with the assistance of a human).

In some embodiments, a process of encryption may be used to transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back into plaintext. An example of an asymmetric key algorithm is the RSA algorithm.

Numerous embodiments are described in the present application, and are presented for illustrative purposes only. The described embodiments are not, and are not intended to be, limiting in any sense. The present disclosure disclosed invention is widely applicable to numerous embodiments, as is readily apparent from the disclosure. One of ordinary skill in the art will recognize that the disclosed invention present disclosure may be practiced with various modifications and alterations, such as structural, logical, software, and electrical modifications. Although particular features of the disclosed present disclosure invention may be described with reference to one or more particular embodiments and/or drawings, it should be understood that such features are not limited to usage in the one or more particular embodiments or drawings with reference to which they are described, unless expressly specified otherwise.

What is claimed is:

1. A method of operating a distributed trading platform comprising:
controlling, by at least one processor:
monitoring, over a communication network in real time, trading activity information indicating trading activities of respective second participants, in which the second participants are liquidity takers;
determining in real time toxicity ratings respectively for the second participants, based on the trading activity information;
receiving, over the communication network from a first participant system of a liquidity provider, a first order;
automatically in response to receiving the first order and in real time,
determining toxicity augments from the toxicity ratings respectively of the second participants, and
transmitting, over the communication network, first order display information to second participant systems respectively of the second participants, to cause display on a graphical user interface (GUI) of a display of each second participant system of the second participant systems of an indication of the first order with the toxicity augment corresponding to the second participant;
receiving, over the communication network from a given second participant system of the second participant systems, a contra order;
in response to receiving the contra order, transmitting the contra order, over the communication network, to the first participant system;
receiving, over the communication network from the first participant system, an indication that a quantity of a financial instrument indicated in the first order is reserved; and
in response to receiving the indication that the quantity of the financial instrument is reserved, facilitating execution of an exchange that fulfills at least a part of each of the contra order and the first order.

2. The method of claim 1, in which a given toxicity augment for a given second participant of the second participants is determined as a function of a given toxicity level corresponding to the given second participant.

3. The method of claim 1, in which a given toxicity augment for a given second participant of the second participants is determined from a look-up table indicating given toxicity augments for respective toxicity levels.

4. The method of claim 1, in which the trading activities information includes real time market data received over the communication network from a remote market data provider.

5. The method of claim 1, in which a given toxicity augment of a given second participant of the second participants is transmitted over the communication network as part of given display information to a given second participant system of the given second participant.

6. The method of claim 1, in which an amount equal to a sum of a given toxicity augment of a given second participant of the second participants and a price of the first order is transmitted over the communication network as part of given display information to a given second participant system of the given second participant.

7. The method of claim 1, in which the indication displays the first order with the respective toxicity augment indicated separately from an indication of a price of the first order.

8. The method of claim 1, in which the indication displays the first order with the respective toxicity augment incorporated into an indication of a price of the first order.

9. The method of claim 1, in which the transmitting, over the communication network, the first order display information to the second participant systems causes simultaneously displaying different toxicity augments with a price of the first order on the displays respectively of the second participant systems.

10. The method of claim 1, further comprising controlling, by at least one processor:
causing, over the communication network, display of a shot clock on the GUI of the display of at least one second participant system of the second participant systems to indicate a countdown of available time remaining for at least one second participant corresponding to the at least one second participant system to react to the first order.

11. The method of claim 10, further comprising controlling, by at least one processor:
automatically responsive to a determination that there is no time remaining for the at least one second participant to react to the first order,
causing, over the communication network, refreshing of the display on the GUI such that (i) the shot clock indicates the available time is expired and (ii) an indication operable to request to execute a trade fulfilling the first order displayed on the GUI is replaced by an indication operable to request to refresh of the first order.

12. The method of claim 11, further comprising controlling, by at least one processor:
automatically responsive to a determination the indication to request to refresh the first order is operated and receiving an indication that a second quantity of the financial instrument indicated in the first order is reserved,
facilitating execution of an exchange that fulfills at least a part of each of the contra order and the first order.

13. The method of claim 1, further comprising controlling, by at least one processor:
determining for given second participants of the second participants updated toxicity augments from the toxicity ratings respectively of the given second participants; and
automatically responsive to determining the updated toxicity augments, transmitting, in real time over the communication network, the updated toxicity augments respectively to given second participant systems of the given second participants, to cause refreshing of the graphical user interface of each of the given second participant systems to display the updated toxicity augment instead of the toxicity augment respectively corresponding to the given second participant system.

14. The method of claim 1, further comprising controlling, by at least one processor:
determining whether the second participants are qualified to view the first order.

15. The method of claim 1, further comprising controlling, by at least one processor:
transmitting the first order display information, over the communication network, to cause display on the GUI of each of the second participant systems indicia as a button operable to accept the first order with the toxicity augment.

16. The method of claim 1, further comprising controlling, by at least one processor:
securely storing, in a database, trading intentions of the liquidity provider received over the communication network from the first participant system.

17. The method of claim 16, in which the trading intentions are encrypted as received over the communication network, and in which the at least one processor controls:
decrypting the trading intentions; and
storing the trading intentions in decrypted form in the database.

18. The method of claim 1, in which the first order display information is transmitted encrypted respectively to the second participant systems.

19. A distributed trading system comprising:
a first participant system of a liquidity provider, in which the first participant system includes a first computing device configured to control:
identifying a first order for distributed order matching entered at a trader interface of the first participant system, and
transmitting, over a communication network, the first order to a central system of the distributed trading system; and
the central system comprising a second computing device configured to control:
monitoring, over the communication network in real time, trading activity information indicating trading activities of respective second participants, in which the second participants are liquidity takers;
determining in real time toxicity ratings respectively for the second participants, based on the trading activity information;
receiving, over the communication network from the first participant system, the first order; and
automatically in response to receiving the first order and in real time,
determining toxicity augments from the toxicity ratings respectively of the second participants, and
transmitting, over the communication network, first order display information to second participant systems respectively of the second participants, to cause display on a graphical user interface of a display of each second participant system of the second participant systems of an indication of the first order with the toxicity augment corresponding to the second participant;
receiving, over the communication network from a given second participant system of the second participant systems, a contra order;
in response to receiving the contra order, transmitting the contra order, over the communication network, to the first participant system;
receiving, over the communication network from the first participant system, an indication that a quantity of a financial instrument indicated in the first order is reserved; and
in response to receiving the indication that the quantity of the financial instrument is reserved, facilitating execution of an exchange that fulfills at least a part of each of the contra order and the first order,
in which the first computing device is configured to control:
receiving, over the communication network, the contra order; and
transmitting, over the communication network, the indication that the quantity of the financial instrument indicated in the first order is reserved.

20. The distributed trading system of claim 19, further comprising the second participant systems,
in which each of the second participant systems includes a third computing device configured to control:
receiving, over the communication network, the first order display information;
rendering on the graphical user interface the indication of the first order with the toxicity augment corresponding to the second participant; and
transmitting, over the communication network, a given contra order.
